(19) United States
(12) Patent Application Publication
(10) Pub. No.: US 2026/0296479 A1
(43) Pub. Date: Oct. 1, 2026

(54) METHOD AND SYSTEM FOR INTUITIVE VEHICLE AWARENESS DURING DRIVING

(71) Applicant: American Honda Motor Co., Inc., Torrance, CA (US)

(72) Inventor: Gopinath RAJA, Redondo Beach, CA (US)

(21) Appl. No.: 19/094,064

(22) Filed: Mar. 28, 2025

(51) Int. Cl. B60W 50/16; B60K 35/25; B60K 35/28; B60K 35/29; B60W 50/14

(52) U.S. Cl. CPC B60W 50/16; B60K 35/25; B60K 35/28; B60K 35/29; B60K 2360/178; B60K 2360/184; B60K 2360/1868; B60K 2360/188; B60K 2360/577; B60W 2050/146; B60W 2420/403; B60W 2420/408; B60W 2420/54

(57) ABSTRACT

A method and system for intuitive vehicle awareness during driving of a vehicle. In one embodiment, the method includes receiving data associated with at least one subject vehicle on a roadway on which the vehicle is traveling from one or more advanced driver assistance systems onboard the vehicle. The method also includes determining a warning level and a location of the at least one subject vehicle based on the received data. The method further includes providing an indication on at least one display within an interior of the vehicle that is disposed in an area of the display that corresponds to the location of the at least one subject vehicle relative to the vehicle.

### BACKGROUND

This disclosure relates generally to warning systems for vehicles, and more particularly to a method and system for intuitive vehicle awareness during driving.

Advances in autonomous driving systems for vehicles are reducing the amount of participation required by a human driver. However, even when a vehicle is being driven in various levels of autonomous modes, the human driver or other occupants of the vehicle may feel anxiety about other vehicles and obstacles on the roadway. For example, occupants of an autonomous vehicle may be focusing on one or more displays in the vehicle, such as a display of the vehicle’s infotainment system or a user device. When shifting focus from the display to the surroundings around the autonomous vehicle, the occupants may feel unease that the vehicle may not properly respond to the other vehicles in its immediate area on the roadway.

There is a need in the art for an improved method and system for intuitive vehicle awareness during driving to communicate information about a vehicle’s surroundings to a vehicle occupant.

### SUMMARY

In one aspect, a method for intuitive vehicle awareness during driving of a vehicle is provided. The method includes receiving data associated with at least one subject vehicle on a roadway on which the vehicle is traveling from one or more advanced driver assistance systems onboard the vehicle. The method also includes determining a warning level and a location of the at least one subject vehicle based on the received data. The method further includes providing an indication on at least one display within an interior of the vehicle that is disposed in an area of the display that corresponds to the location of the at least one subject vehicle relative to the vehicle.

In another aspect, a system in a vehicle for intuitive vehicle awareness during driving is provided. The system includes at least one advanced driver assistance system located on the vehicle, an in-vehicle infotainment system comprising a processor and a display, and a plurality of vehicle sensors. The processor is configured to receive data associated with at least one subject vehicle on a roadway on which the vehicle is traveling from the at least one advanced driver assistance system onboard the vehicle, determine a warning level and a location of the at least one subject vehicle based on the received data, and provide an indication on at least the display of the in-vehicle infotainment system that is disposed in an area of the display that corresponds to the location of the at least one subject vehicle relative to the vehicle.

In still another aspect, a method for intuitive vehicle awareness during driving of a vehicle is provided. The method includes receiving at least one indication on a user device of an occupant of the vehicle during autonomous driving of the vehicle. The at least one indication includes information about a proximity and a location of at least one subject vehicle on a roadway on which the vehicle is traveling. The at least one indication is displayed on the display of the user device with at least one of a color, hue, pattern, or intensity that corresponds to the proximity of the at least one subject vehicle. The at least one indication is displayed in an area on the display of the user device that corresponds to the location of the at least one subject vehicle relative to the vehicle

Other systems, methods, features and advantages of the disclosure will be, or will become, apparent to one of ordinary skill in the art upon examination of the following figures and detailed description. It is intended that all such additional systems, methods, features and advantages be included within this description and this summary, be within the scope of the disclosure, and be protected by the following claims.

### BRIEF DESCRIPTION OF THE DRAWINGS

The disclosure may be better understood with reference to the following drawings and description. The components in the figures are not necessarily to scale, emphasis instead being placed upon illustrating the principles of the disclosure. Moreover, in the figures, like reference numerals designate corresponding parts throughout the different views.

FIG. 1 is a schematic block diagram of an example embodiment of a vehicle that includes a system for intuitive vehicle awareness in accordance with aspects of the present disclosure;

FIG. 2 is a representative view of an example embodiment of an autonomous vehicle with a plurality of types of advanced driver assistance systems in accordance with aspects of the present disclosure;

FIG. 3 is a representative view of an example embodiment of an interior of a vehicle that includes a system for intuitive vehicle awareness in accordance with aspects of the present disclosure;

FIG. 4 is a representative view of an example embodiment of a system for intuitive vehicle awareness illustrating a first example scenario in accordance with aspects of the present disclosure;

FIG. 5 is a representative view of an example embodiment of a system for intuitive vehicle awareness illustrating a second example scenario in accordance with aspects of the present disclosure;

FIG. 6 is a representative view of an example embodiment of a system for intuitive vehicle awareness illustrating a third example scenario in accordance with aspects of the present disclosure; and

FIG. 7 is a flowchart of an example embodiment of a method of providing intuitive vehicle awareness during autonomous driving in accordance with aspects of the present disclosure.

### DETAILED DESCRIPTION

A method and system for intuitive vehicle awareness during driving of a vehicle is described herein. The techniques of the present embodiments may be used to provide warnings or indications to a vehicle’s occupants of other vehicles in the immediate vicinity of the autonomous vehicle through one or more displays in the vehicle. The warnings or indications on the displays are provided in a non-intrusive manner and are configured to inform the vehicle’s occupants about the proximity and/or location of the other vehicles surrounding the autonomous vehicle.

The example embodiments are described herein with reference to an autonomous vehicle. However, it should be understood that the principles of the example embodiments described herein may be applied with reference to any vehicle. A “vehicle”, as used herein, refers to any moving vehicle that is capable of carrying one or more human occupants and is powered by any form of energy. The term “vehicle” includes, but is not limited to: cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” may refer to an electric vehicle (EV) that is capable of carrying one or more human occupants and is powered entirely or partially by one or more electric motors powered by an electric battery. The EV may include battery electric vehicles (BEV) and plug-in hybrid electric vehicles (PHEV). For the purposes of this disclosure, autonomous vehicles include partially or fully autonomous vehicles, including self-driving vehicles. An autonomous vehicle may or may not carry one or more human occupants.

Autonomous vehicle functionality may be provided to various degrees or levels. For example, the Society of Automotive Engineers (SAE) has published definitions for levels of automation pertaining to autonomous vehicles as follows. At Level 0, the human driver does everything. At Level 1, an automated system on the vehicle may sometimes assist the human driver perform some parts of driving, such as braking assistance. At Level 2, an automated system on the vehicle may perform some parts of driving, while the human driver continues to monitor the driving environment and performs the rest of the driving task, such as cruise control or lane keeping assistance. At Level 3, an automated system may both actually conduct some parts of driving and also actively monitor the driving environment, while the human driver is ready to take back control upon request from the automated system, such as a vehicle travelling on a highway maintaining itself within a lane and at a safe distance between another vehicle. In some circumstances, the human driver may be required to take control of the vehicle, for example, when the other vehicle departs from its lane. At Level 4, an automated system may conduct driving and also monitor the driving environment with the human occupant not needing to take back control during operation only in certain environments and under certain conditions. At Level 5, the automated system may perform all driving tasks, under all conditions that a human driver could perform them.

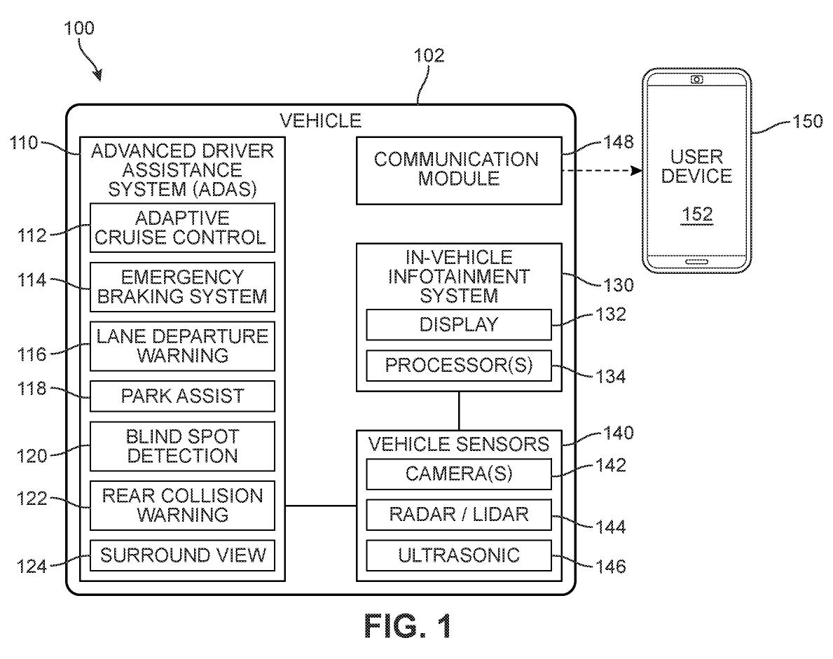

Referring now to FIG. 1, a block diagram of an example embodiment of a system 100 for intuitive vehicle awareness in a vehicle 102 is shown. In this embodiment, vehicle 102 is an autonomous vehicle that is capable of at least partially autonomous driving from an advanced driver assistance system (ADAS) 110. In various embodiments, ADAS 110 may include one or more types of advanced driving assistance functions as defined by SAE, as described above, such as adaptive cruise control (ACC), forward collision warning (FCW), advanced emergency braking (AEB), pedestrian detection (PD), traffic sign recognition (TSR), lane departure warming (LDW), driver monitor (DM), among other SAE level 2 and higher autonomous driving functions. These example advanced driving assistance functions may use one or more machine learning models and/or deep learning models to respond to observed driving events, objects, and/or hazards.

In an example embodiment, ADAS 110 in vehicle 102 may include one or more of the following systems: adaptive cruise control 112, emergency braking 114, lane departure warning 116, park assist 118, blind spot detection 120, rear collision warning 122, and surround view 124. In some implementations, vehicle 102 may include any number of systems 112-124 as part of ADAS 110 and need not include all of the systems shown in the example embodiment of FIG. 1. Additionally, in other implementations, other types of advanced driver assistance systems may also be optionally, alternatively, or additionally included in vehicle 102 as part of ADAS 110, as described above.

In an example embodiment, vehicle 102 includes a human machine interface (HMI) in the form of an in-vehicle infotainment (IVI) system 130. IVI system 130 may include at least a display 132 for presenting information, images, and/or video to occupants of vehicle 102 and at least one processor 134 associated with IVI system 130. In one embodiment, processor 134 may be part of an electronic control unit (ECU) or vehicle control unit that is configured to control or communication with at least one or more systems of vehicle 102. In some embodiments, IVI system 130, including processor 134, may communicate with and/or receive data from one or more systems of ADAS 110 over a controller area network (CAN) bus (not shown) or other type of vehicle component communication system.

In some embodiments, autonomous vehicle 102 may be provided with a plurality of vehicle sensors 140 that are configured to detect and monitor objects and surroundings near autonomous vehicle 102, as well as determine location, orientation, speed, heading, and other information associated with the position and/or movement of autonomous vehicle 102. In this embodiment, sensors 140 includes at least one or more cameras 142, a radar and/or LIDAR system 144, and at least one ultrasonic sensor 146. In other embodiments, vehicle sensors 140 may further include other sensors used to assist autonomous vehicle 102 during operation and travel.

In some embodiments, vehicle 102 may also include a communication module 148. Communication module may include components for communicating with other vehicles, devices, users, etc. using one or more forms of wireless communication technology. For example, in this embodiment, communication module 148 includes at least short-range wireless communication technology, such as Bluetooth and/or WiFi, configured to allow autonomous vehicle 102 to receive and/or transmit information with at least one user device 150. In an example embodiment, user device 150 may be a smartphone or tablet that includes a display 152. In other embodiments, user device 150 may be other types of mobile devices equipped with a display for communicating with a user.

Additionally, communication module 148 may further include various cellular communication technologies, such as 3G, 4G, 5G, etc. wireless networks, configured to allow autonomous vehicle 102 to receive and/or transmit information with other vehicles, devices, and/or computers. In other embodiments, communication module 148 may include any other form of wireless communication technology, including components that allow autonomous vehicle 102 to communicate using Wireless Wide Area Networks (WWAN), Wireless Local Area Networks (WLAN), and/or other forms of wireless communication technology.

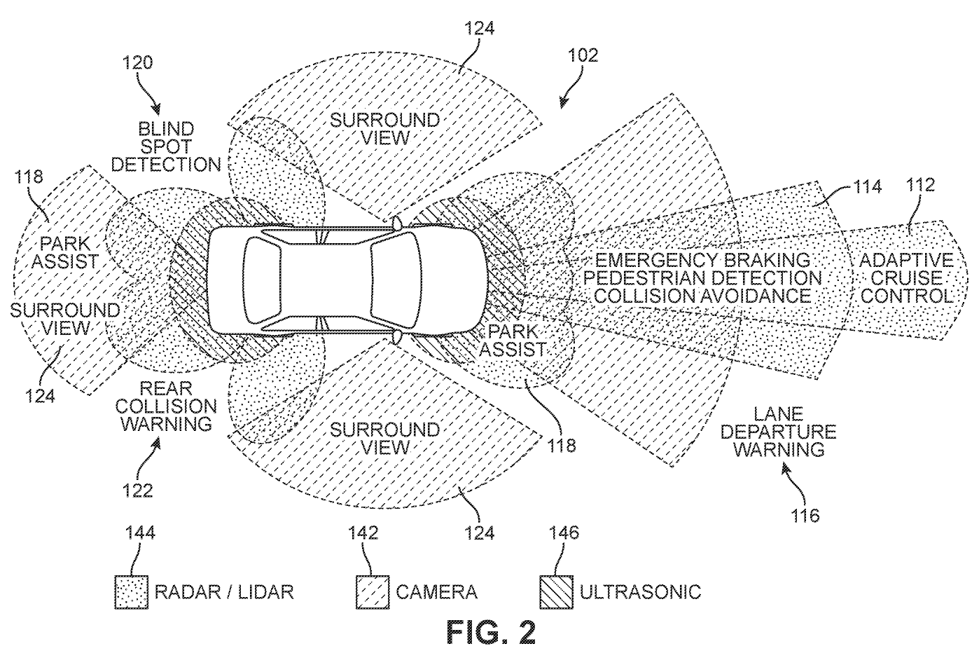

Referring now to FIG. 2, a representative view of an example embodiment of autonomous vehicle 102 with a plurality of types of advanced driver assistance systems is shown. In an example embodiment, vehicle 100 may be equipped with one or more systems associated with ADAS 110, as described above. In this embodiment, vehicle 102 includes adaptive cruise control 112, emergency braking 114, lane departure warning 116, park assist 118, blind spot detection 120, rear collision warning 122, and surround view 124 that use one or more of vehicle sensors 140, including cameras 142, radar and/or LIDAR system 144, and ultrasonic sensor 146, to detect the areas surrounding vehicle 102, such as other vehicles and objects on the roadway near and around vehicle 102.

According to the techniques of the present embodiments described herein, the data and information from one or more of systems 112-124 of ADAS 110 in autonomous vehicle 102 may be used to provide warnings or indications to occupants in vehicle 102 about the proximity and/or location of other vehicles in the immediate vicinity of autonomous vehicle 102 through one or more displays in vehicle 102, including display 152 of user device 150 and display 132 of IVI system 130, described above. With this arrangement, occupants of vehicle 102 may feel less unease or anxiety during autonomous driving.

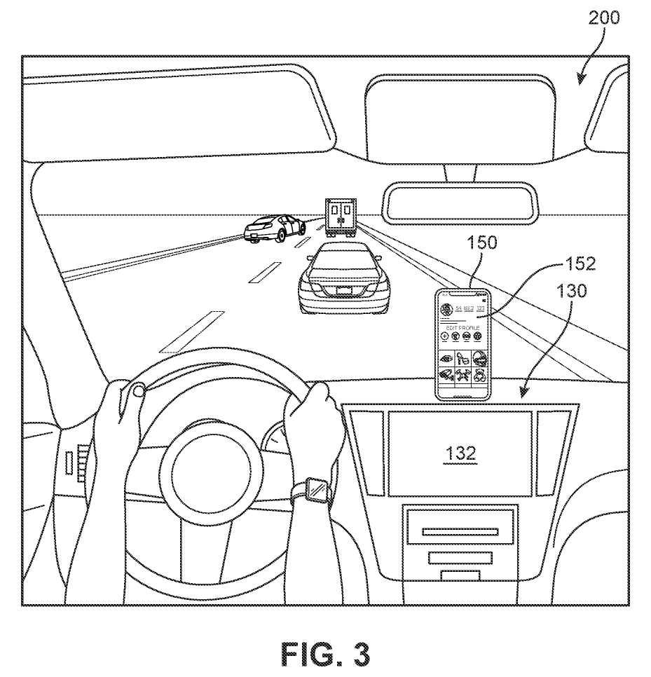

Referring now to FIG. 3, an interior 200 of vehicle 102 is shown. In this embodiment, interior 200 of vehicle 102 includes IVI system 130 with display 132 and user device 150, such as a smartphone, with display 152. In some embodiments, user device 150 may be paired or connected to system 100 of vehicle 102 using short-range communication technologies, such as Bluetooth or WiFi, via communication module 148 (shown in FIG. 1) to enable warnings and/or indications about the proximity of vehicle 102 to other vehicles to be shown on display 152 of user device 150. In other embodiments, user device 150 may be configured to run an application that enables the warnings and/or indications from system 100 to be shown on display 152, but which application also allows a user to open and run other applications at the same time. With this arrangement, the warnings and/or indications may be shown on display 152 of user device 150 while the user is otherwise using user device 150 for other tasks or applications.

In an example embodiment, the warnings and/or indications from system 100 may be displayed simultaneously on both of user device 150 and IVI system 130. In other embodiments, the warnings and/or indications from system 100 may be displayed only on one of user device 150 or IVI system 130. In some cases, the user may be provided with an option to enable simultaneous display on both of user device 150 and IVI system 130, only user device 150, or only IVI system 130.

In this embodiment, user device 150 is shown mounted above IVI system 130, however, it should be understood that the techniques of the present embodiments may be provided to a user device located anywhere inside interior 200 of vehicle 102. Additionally, the techniques described herein may be applied to more than one user device inside interior 200 of vehicle 102. For example, in some cases, two or more occupants of vehicle 102 may have separate user devices that are configured to communicate with systems of vehicle 102 via communication module 148, described above. With this arrangement, more than one occupant of vehicle 102 may be provided with warnings or indications on their user devices about the proximity and/or location of other vehicles surrounding autonomous vehicle 102.

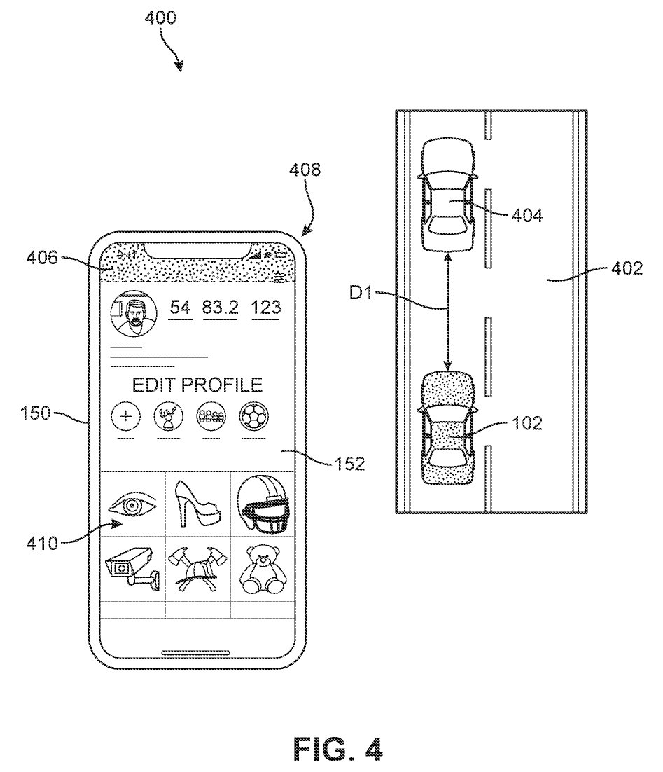

Referring now to FIG. 4, a representative view of a first example scenario 400 in which system 100 for intuitive vehicle awareness in vehicle 102 is demonstrated. In this embodiment, only display 152 of user device 150 is shown, however, it should be understood that display 132 of IVI system 130 may also present a substantially similar warning and/or indication to the user according to the techniques described herein. In first example scenario 400, autonomous vehicle 102 is traveling on a roadway 402 with a subject vehicle 404 located in the same lane as vehicle 102 at a first distance D1 in front of vehicle 102.

According to the techniques of the present embodiments, data and information received from one or more systems of ADAS system 110 in vehicle 102 may be used by system 100 to provide proximity and location information to occupants of vehicle 102 about subject vehicle 404. In this embodiment, a first indication 406 about the proximity and location of subject vehicle 404 is presented on display 152 of user device 150. In some embodiments, the warnings and/or indications shown on display 152 of user device 150 (as well as on display 132 of IVI system 130) are configured to provide proximity and location information to the user by varying a color, hue, pattern, or intensity of the indication and by varying a location or area on the display where the indication is shown.

In some embodiments, the color, hue, pattern, or intensity of the warning and/or indication may vary between different levels that correspond to the proximity of other vehicles. For example, a first color, hue, pattern, or intensity may correspond to a low warning level associated with a first threshold distance, a second color, hue, pattern, or intensity may correspond to a medium warning level associated with a second threshold distance that is smaller than the first threshold distance (i.e., indicating the other vehicle(s) are closer to vehicle 102), and a third color, hue, pattern, or intensity may correspond to a high or urgent warning level associated with a third threshold distance that is smaller than both the first threshold distance and the second threshold distance (i.e., indicating the other vehicle(s) are very close to vehicle 102).

In some embodiments, the warning levels may include threshold distances, speeds, and/or acceleration. In an example embodiment, the thresholds associated with the different warning levels may be predetermined based on the settings of the one or more systems of ADAS 110. In other words, the one or more systems 112-124 associated with ADAS 110 may be already programmed with defined thresholds that correspond to different levels of actions or responses based on the data and information about vehicle 102 and other vehicles received from vehicle sensors 140. In an alternative embodiment, a user may define the thresholds that correspond to different levels of actions or responses. For instance, a user may determine a setting for how responsive or intense the warning levels are for far, close, and very close vehicle distances. In these embodiments, the warning levels presented to occupants of vehicle 102 as part of system 100 use the warning levels received from ADAS 110.

For example, in the case of emergency braking system 114, a low level warning may cause emergency braking system 114 to reduce throttle or accelerator input, a medium level warning may cause emergency braking system 114 to implement regenerative or engine braking to reduce the speed of vehicle 102, and a high or urgent warning level may cause emergency braking system 114 to engage the braking system of vehicle 102 to mechanically slow the wheels of vehicle 102. System 100 for intuitive vehicle awareness may translate the warnings and responses from emergency braking system 114 into corresponding warnings and/or indications on the displays inside vehicle 102 to the occupants.

In some embodiments, color, hue, pattern, or intensity of the indication may be varied on the display using different levels of opacity. For example, the first color, hue, pattern, or intensity displayed on display 152 of user device 150 may be semi-transparent, while the second color, hue, pattern, or intensity displayed on display 152 may be less transparent and more opaque and the third color, hue, pattern, or intensity may be mostly opaque. With this arrangement, the opacity of the indications on the display may vary in correspondence with the warning level so that as other vehicles are closer to vehicle 102, the opacity of the indication increases.

In other embodiments, different colors may be used to show the various warning levels. For example, a green color may be used to display the low warning level associated with the first threshold distance, a yellow color may be used to display the medium warning level associated with the second threshold distance, and a red color may be used to display the high or urgent warning level with the third threshold distance. In still other embodiments, user device 150 may include a haptic mechanism and varying haptic intensities or different haptic patterns (e.g., sequences of vibrations) may be used to denote the different warning levels. In some cases, two or more of intensity/opacity, color, hue, pattern, and haptic vibrations may be used in combination to provide the warnings and/or indications to the occupants of vehicle 102. In some embodiments, the types of warnings and/or indications and how they are presented on the displays of user device 150 and/or IVI system 130 may be user selectable.

In an embodiment, a pattern of a warning and/or indication may include any one or more of dots, lines, shapes, or figures, arranged in any manner.

In an example embodiment, a color, hue, pattern, or intensity of first indication 406 provides information about a proximity or warning level severity between vehicle 102 and subject vehicle 404. For example, in first scenario 400, vehicle 102 and subject vehicle 404 are separated by first distance D1. In this embodiment, first distance D1 may be a low warning level associated with a first threshold distance, but not less than a second threshold distance. First indication 406 is shown on display 152 of user device 150 with a first intensity that is mostly transparent or semi-transparent. With this arrangement, the user of user device 150 may be using other applications 410 on user device 150 while first indication 406 is present on display 152 in a non-intrusive manner.

In first scenario 400, subject vehicle 404 is directly in front of vehicle 102 and first indication 406 is disposed entirely across a top portion 408 of display 152 of user device 150. That is, the location of first indication 406 on the display (e.g., display 152 shown in FIG. 4) corresponds to the location of the other vehicle(s) in proximity to vehicle 102. With this arrangement, system 100 is configured to provide location information to occupants of vehicle 102 by varying the location of the warning and/or indication that is shown on the display.

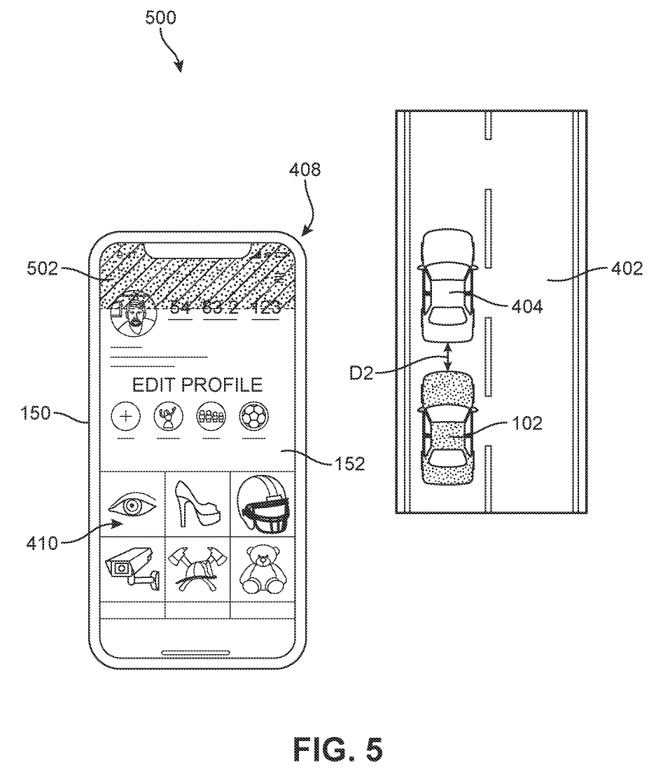

FIG. 5 is a representative view of a second example scenario 500 in which system 100 for intuitive vehicle awareness in vehicle 102 is demonstrated. In this embodiment, only display 152 of user device 150 is shown, however, it should be understood that display 132 of IVI system 130 may also present a substantially similar warning and/or indication to the user according to the techniques described herein. In second example scenario 500, autonomous vehicle 102 is traveling on roadway 402 with subject vehicle 404 located in the same lane as vehicle 102 at a second distance D2 in front of vehicle 102.

In second example scenario 500, second distance D2 is smaller than first distance D1 from first example scenario 400. Accordingly, second indication 502 about the proximity and location of subject vehicle 404 presented on display 152 of user device 150 has a higher intensity level, and may have a different pattern, than first indication 406 shown in FIG. 4. For example, in this case, second indication 502 is less transparent and more opaque than first indication 406. In this manner, because second distance D2 is smaller than first distance D1 (e.g., subject vehicle 404 and vehicle 102 are closer to each other) the warning level is higher and second indication 502 is shown on display 152 with a greater intensity. With this arrangement, the greater opacity of second indication 502 may attract the user’s attention more than first indication 406 while the user of user device 150 may be using other applications 410 on user device 150.

In second scenario 500, subject vehicle 404 is again directly in front of vehicle 102 and second indication 502 is disposed entirely across top portion 408 of display 152 of user device 150. In other scenarios, for example, when other vehicles in proximity of vehicle 102 are in adjacent lanes (e.g., to the left or right of vehicle 102), then the warning and/or indication may be disposed to one side or the other of the display to correspond to the side on which the other vehicle(s) are detected.

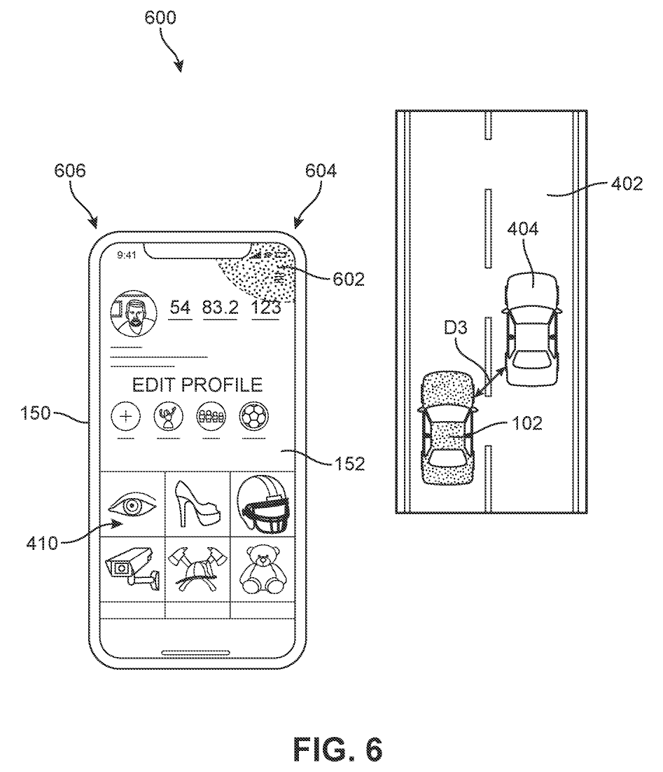

Referring now to FIG. 6, a representative view of a third example scenario 600 in which system 100 for intuitive vehicle awareness in vehicle 102 is demonstrated. In this embodiment, only display 152 of user device 150 is shown, however, it should be understood that display 132 of IVI system 130 may also present a substantially similar warning and/or indication to the user according to the techniques described herein. In third example scenario 600, autonomous vehicle 102 is traveling on roadway 402 with subject vehicle 404 located in an adjacent lane next to vehicle 102.

In third example scenario 600, a third indication 602 about the proximity and location of subject vehicle 404 presented on display 152 of user device 150. As shown in FIG. 6, vehicle 102 is in an adjacent lane diagonally separated from subject vehicle 404 by a third distance D3 and is not traveling on a course that is likely to collide with subject vehicle 404. In this embodiment, therefore, third indication 602 has a low intensity level that is more transparent and less opaque than second indication 502. In contrast with first scenario 400 and second scenario 500, subject vehicle 404 is not directly in front of vehicle 102, but rather is located to the right of vehicle 102 in the adjacent lane. Accordingly, third indication 602 is disposed only in an upper right corner 604 of display 152 of user device 150. That is, because subject vehicle 404 is located to the right of vehicle 102, third indication 602 is shown in the corresponding upper right corner 604 of display 152 and third indication 602 does not extend into the opposite corner, upper left corner 606 of display 152. In this manner, the location of subject vehicle 404 (e.g., to the right of vehicle 102 in the adjacent lane) may be communicated to the occupants of vehicle 102 through the location of third indication 602 on display 152 of user device 150.

While the example scenarios 400, 500, 600 shown in FIGS. 4, 5, and 6 illustrate a vehicle in front of and/or adjacent to vehicle 102, it should be understood that the techniques of the present embodiments may also be used to provide warnings and/or indications when other vehicles are behind and/or adjacent to vehicle 102. In these cases, a bottom portion of display 152 of user device 150, a lower right corner, or a lower left corner may include the warning and/or indication of the other vehicle in a similar manner as described above. Warning and/or indication locations on display 152 may correspond the locations of other vehicles based on a bird’s eye view of roadway 402.

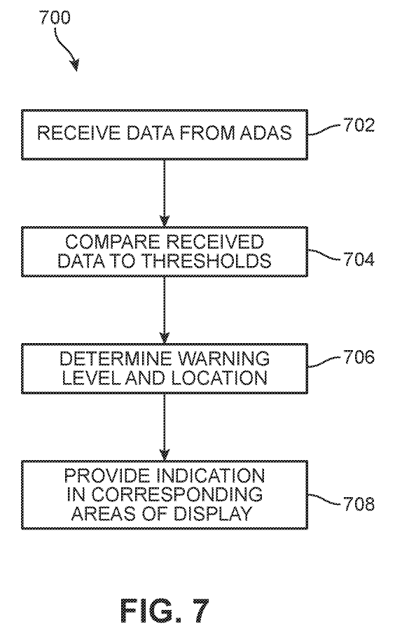

FIG. 7 is a flowchart of an example embodiment of a method 700 of providing intuitive vehicle awareness during autonomous driving. In some embodiments, method 700 may be implemented by one or more processors of vehicle 102, including, for example, processor 134 of IVI system 130, described above in reference to FIG. 1. In an example embodiment, method 700 may begin at an operation 702. At operation 702, data and information about one or more other vehicles in proximity to vehicle 102 from one or more systems of ADAS 110 is received. For example, at operation 702, one or more systems 112-124 may send data and information to processor 134 about the proximity, location, speed, acceleration, etc. of other vehicles or other objects on the roadway around vehicle 102 from one or more of vehicle sensors 140, described above.

Next, at an operation 704, the received data from operation 702 is compared to one or more threshold values. For example, as described above, the threshold values may be separation distances, speed, acceleration, changes in acceleration, or other values that are used by one or more systems of ADAS 110 to determine action responses and warnings. Method 700 may then proceed to an operation 706 where the comparison from operation 704 is used to generate a warning level (e.g., intensity/opacity, color, hue, pattern, and/or haptic vibration) and a direction (e.g., in front, to the left, the right, behind), as described above and in reference to first example scenario 400, second example scenario 500, and third example scenario 600.

At an operation 708, method 700 includes providing the indication in the corresponding areas of the display as the location of the other vehicle relative to vehicle 102. For example, at operation 708, the indication may be shown along the entirety of top portion 408 of display 152 of user device 150 when a vehicle is located directly in front of vehicle 102, as in the case of first indication 406 (shown in FIG. 4) and second indication 502 (shown in FIG. 5). In another example, at operation 708, the indication may instead be shown in one corner when a vehicle is in an adjacent lane to one side or the other of vehicle 102, as in the case of third indication 602 (shown in FIG. 6). In a similar manner, the warning and/or notification may be presented on the displays in areas that correspond to the location of the other vehicle(s) detected in the proximity of vehicle 102. With this arrangement, method 700 of providing intuitive vehicle awareness during autonomous driving may allow occupants of an autonomous vehicle (e.g., vehicle 102) to be informed about the proximity and/or location of the other vehicles surrounding the autonomous vehicle in a non-intrusive manner.

It is noted that other vehicles may be presented on the display in different colors, hues, patterns, and intensities, depending on their distance from vehicle 102, and at the same time. Thus, multiple warnings, indications, and/or notifications (e.g. first indication 406, second indication 502, and third indication 602) may be displayed on display 152 of user device 150. Furthermore, the embodiments herein are not limited to a single display, but may operate on multiple of user device 150 and/or display 132 of IVI system 130 at the same time.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

While various embodiments of the disclosure have been described, the description is intended to be exemplary, rather than limiting and it will be apparent to those of ordinary skill in the art that many more embodiments and implementations are possible that are within the scope of the disclosure. It is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims. Accordingly, the disclosure is not to be restricted except in light of the attached claims and their equivalents. Also, various modifications and changes may be made within the scope of the attached claims.

1. A method for intuitive vehicle awareness during driving of a vehicle, the method comprising:
receiving data associated with at least one subject vehicle on a roadway on which the vehicle is traveling from one or more advanced driver assistance systems onboard the vehicle;
determining a warning level and a location of the at least one subject vehicle based on the received data; and
providing an indication on at least one display within an interior of the vehicle that is disposed in an area of the display that corresponds to the location of the at least one subject vehicle relative to the vehicle.

2. The method according to claim 1, wherein the indication is displayed with at least one of a color, hue, pattern, or intensity that corresponds the determined warning level.

3. The method according to claim 1, wherein the at least one display includes a display associated with an in-vehicle infotainment system and/or a display associated with a user device.

4. The method according to claim 3, further comprising:
simultaneously displaying the indication on both of the display associated with the in-vehicle infotainment system and the display associated with the user device.

5. The method according to claim 1, wherein the one or more advanced driver assistance systems acquire data associated with the at least one subject vehicle using one or more vehicle sensors.

6. The method according to claim 5, wherein the vehicle sensors include at least one camera, a radar or LIDAR sensor, and an ultrasonic sensor.

7. The method according to claim 1, wherein determining the warning level includes comparing the received data associated with the at least one subject vehicle to threshold values.

8. The method according to claim 7, wherein the threshold values are set by a user.

9. A system in a vehicle for intuitive vehicle awareness during driving comprising:
at least one advanced driver assistance system located on the vehicle;
an in-vehicle infotainment system comprising a processor and a display;
a plurality of vehicle sensors;
wherein the processor is configured to:
receive data associated with at least one subject vehicle on a roadway on which the vehicle is traveling from the at least one advanced driver assistance system onboard the vehicle;
determine a warning level and a location of the at least one subject vehicle based on the received data; and
provide an indication on at least the display of the in-vehicle infotainment system that is disposed in an area of the display that corresponds to the location of the at least one subject vehicle relative to the vehicle.

10. The system according to claim 9, wherein the indication is displayed with at least one of a color, hue, pattern, or intensity that corresponds the determined warning level.

11. The method according to claim 9, further comprising a display associated with a user device.

12. The system according to claim 11, wherein the processor is further configured to:
simultaneously display the indication on both of the display associated with the in-vehicle infotainment system and the display associated with the user device.

13. The system according to claim 11, wherein the user device includes a haptic mechanism; and
wherein the indication further includes a sequence of vibrations from the haptic mechanism.

14. The system according to claim 9, wherein the at least one advanced driver assistance system acquires data associated with the at least one subject vehicle using the plurality of vehicle sensors.

15. The system according to claim 14, wherein the plurality of vehicle sensors include at least one camera, a radar or LIDAR sensor, and an ultrasonic sensor.

16. The system according to claim 1, wherein the processor is configured to determine the warning level by comparing the received data associated with the at least one subject vehicle to threshold values.

17. A method for intuitive vehicle awareness during driving of a vehicle, the method comprising:
receiving at least one indication on a user device of an occupant of the vehicle during autonomous driving of the vehicle;
wherein the at least one indication includes information about a proximity and a location of at least one subject vehicle on a roadway on which the vehicle is traveling;
wherein the at least one indication is displayed on the display of the user device with at least one of a color, hue, pattern, or intensity that corresponds to the proximity of the at least one subject vehicle; and
wherein the at least one indication is displayed in an area on the display of the user device that corresponds to the location of the at least one subject vehicle relative to the vehicle.

18. The method according to claim 17, wherein the user device includes a haptic mechanism; and
wherein the at least one indication further includes a sequence of vibrations from the haptic mechanism.

19. The method according to claim 17, wherein the at least one indication is displayed on a user device of at least one additional occupant of the vehicle.

20. The method according to claim 17, wherein the at least one indication is simultaneously displayed on a display of an in-vehicle infotainment system onboard the vehicle.
